(19) United States
(12) Patent Application Publication
(10) Pub. No.: US 2026/0147933 A1
(43) Pub. Date: May 28, 2026

(54) PREVENTION OF INFORMATION LEAKAGE

(71) Applicant: INTERNATIONAL BUSINESS MACHINES CORPORATION, Armonk, NY (US)

(72) Inventors: HENG WANG, Beijing (CN); HERNAN A. CUNICO, HOLLY SPRINGS, NC (US); XIAO LING CHEN, BEIJING (CN); ZHAN PENG HUO, BEIJING (CN)

(21) Appl. No.: 18/962,116

(22) Filed: Nov. 27, 2024

(51) Int. Cl. G06F 21/62; G06F 11/362; G06F 40/205

(52) U.S. Cl. CPC G06F 21/629; G06F 11/362; G06F 40/205

(57) ABSTRACT

Embodiments check that a debugging mode of a code enables a data protection compilation; load a debugging information entry with a new attribute having a true value in response to the debugging mode of the code enabling the data protection compilation; activate a debugging session of the code; parse the debugging information entry with the new attribute; determine that the new attribute has the true value in response to parsing the debugging information entry with the new attribute; generate an enhanced debugging reply packet with a protect flag having the true value in response to determining that the new attribute has the true value; and prevent access of a variable of the code in response to determining that the new attribute has the true value.

### BACKGROUND

Aspects of the present invention relate generally to prevention of information leakage.

Confidential computing is a security and privacy-enhancing computational technique which protects data. In particular, confidential computing is used in conjunction with storage and network encryption to protect stored data and data in transit.

### SUMMARY

In a first aspect of the invention, there is a computer-implemented method including: checking, by a processor set, that a debugging mode of a code enables a data protection compilation; loading, by the processor set, a debugging information entry with a new attribute having a true value in response to the debugging mode of the code enabling the data protection compilation; activating, by the processor set, a debugging session of the code; parsing, by the processor set, the debugging information entry with the new attribute; determining, by the processor set, that the new attribute has the true value in response to parsing the debugging information entry with the new attribute; generating, by the processor set, an enhanced debugging reply packet with a protect flag having the true value in response to determining that the new attribute has the true value; and preventing, by the processor set, access of a variable of the code in response to determining that the new attribute has the true value.

In another aspect of the invention, there is a computer program product including one or more computer-readable storage media; and program instructions stored on the one or more computer-readable storage media to perform operations including: receiving a debugging reply packet which corresponds to a code; parse the debugging reply packet; determining whether a protect flag is true within the debugging reply packet in response to parsing the debugging reply packet; displaying access denied in response to determining that the protect flag is true within the debugging reply packet; and displaying variable of the code in response to determining that the protect flag is not true within the debugging reply packet.

In another aspect of the invention, there is a system including: a processor set; one or more computer-readable storage media; and program instructions stored on the one or more computer-readable storage media to cause the processor set to perform operations comprising: checking that a debugging mode of a code enables a data protection compilation; loading a debugging information entry with a new attribute having a true value in response to the debugging mode of the code enabling the data protection compilation; activating a debugging session of the code; parsing the debugging information entry with the new attribute; determining that the new attribute has the true value in response to parsing the debugging information entry with the new attribute; generating an enhanced debugging reply packet with a protect flag having the true value in response to determining that the new attribute has the true value; outputting the generated enhanced debugging reply packet with the protect flat having the true value; and preventing access of a variable of the code in response to determining that the new attribute has the true value.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an example of a debugging information file format of the compiler module in accordance with aspects of the present invention.

FIG. 4 shows an example of a new attribute of the debugging server module in accordance with aspects of the present invention.

FIG. 5 shows an example of parsing the debugging information filing format of the debugging server module in accordance with aspects of the present invention.

FIG. 6 shows an example of a debugging reply packet of the debugging server module in accordance with aspects of the present invention.

FIG. 7 shows a flowchart of an exemplary method in accordance with aspects of the present invention.

FIG. 8 shows a flowchart of an exemplary method in accordance with aspects of the present invention.

### DETAILED DESCRIPTION

Aspects of the present invention relate generally to prevention of information leakage. Embodiments of the present invention provide a leakage prevention system, a computer program product, and computer-implemented method which limits an access of sensitive data. Embodiments of the present invention activate a confidential computing sensitive compilation mode using a compilation keyword ccs. In other words, ccs is a keyword which represents the confidential computing sensitive (ccs) mode. In further embodiments of the present invention, the compilation keyword ccs is a predetermined keyword within a source code which is used as a trigger to denote sensitive and confidential data. In particular, aspects of the present invention provide a system, a computer program product, and computer-implemented method which utilizes the compilation keyword ccs to annotate sensitive information within a microservice source code. Embodiments of the present invention apply the compilation keyword ccs to protect sensitive data elements, including variables, addresses, and functions. Embodiments of the present invention also apply the compilation keyword ccs in an automated process.

Embodiments of the present invention also mark elements with the compilation keyword ccs during a compilation of the microservice source code. Embodiments of the present invention associate any elements marked with the compilation keyword ccs to a new attribute with a name “DW_at_cc_sensitive”. In aspects of the present invention, the new attribute is utilized within the leakage prevention system to trigger a protect flag for protecting sensitive data. Embodiments of the present invention then embed the new attribute into a debugging information entry within a debugging with an attributed record format (DWARF) section of an executable and linkable format (ELF) file.

Embodiments of the present invention enforce access control in response to a debugger processing the ELF file which includes the debugging information entry with the new attribute. Embodiments of the present invention enforce the access control to ensure that access to sensitive information is regulated during a debugging session in response to the debugger attempting to access any debugging information entry marked with the new attribute. Further, embodiments of the present invention protect the debugger server and microservice during a debugging session of a code within the microservice in a confidential computing environment such that an engineer is prevented from bypassing a debugger confidential debugging information entry parse (DCDP) module.

Aspects of the present invention enable secure and efficient debugging of microservices within the confidential computing environment by seamlessly integrating the leakage prevention system within a debug as a service (DasS) model. Embodiments of the present invention protect sensitive data and intellectual property within a microservice during a debugging process within the confidential computing environment. Accordingly, implementations of the present invention reduce a risk of data leakage and unauthorized access. Aspects of the present invention maintain compliance with data privacy and security regulations (i.e., general data protection regulation (GDPR), health insurance portability and accountability act (HIPAA), etc.) during a debugging session to enhance trust with clients and regulators and adhere to the principles of the confidential computing environment. Embodiments of the present invention enhance the DWARF format to protect sensitive data, improve control access permissions for variables and structures, and enable a trusted execution environment (TEE) debugger by adding the new attribute. Accordingly, implementations of the present invention bolster security for clients with stringent security requirements.

Embodiments of the present invention enhance security of debugging within a cloud computing environment by limiting access to sensitive data. In contrast, conventional systems establish a secure channel with a server and manage debugging data exchange within the secure channel. However, conventional systems are not able to limit access to sensitive data without exposing the secure channel with the sever to manage debug data exchange. Therefore, embodiments of the present invention enhance security of debugging a microservice within the confidential computing environment in comparison to conventional systems. Embodiments of the present invention reduce data leakage and unauthorized access by protecting sensitive data contained in microservices during a debugging process.

Embodiments of the present invention include a leakage prevention system, method, and computer program product for limiting access of sensitive data in a microservice within a confidential computing environment, which is necessarily rooted in computer technology. Accordingly, implementations of the present invention provide an improvement (i.e., technical solution) to a problem arising in the technical field of confidential computing. In particular, embodiments of the present invention enhance security of debugging within a cloud computing environment by limiting access to sensitive data. Also, embodiments of the present invention may not be performed in the human mind (or with pen and paper) because aspects of the present invention mark elements with a compilation keyword ccs during a compilation of the microservice source code, associate any elements marked with the compilation keyword ccs to a new attribute named “DW_at_cc_sensitive”, embed the new attribute into a debugging information entry within a debugging with an attributed record format (DWARF) section of an executable and linkable format (ELF) file, and enforce access control in response to a debugger processing the ELF file which includes the debugging information entry with the new attribute. Further, these implementations of the present invention enforce the access control to ensure that access to sensitive information is regulated during a debugging session in response to the debugger attempting to access any debugging information entry marked with the new attribute. Accordingly, it is simply not possible for the human mind, or for a person using pen and paper, to mark elements with a compilation keyword ccs, associate any elements marked with the compilation keyword ccs to the new attribute, embed the new attribute into a debugging information entry within a debugging of an executable and linkable format (ELF) file, and enforce access control in response to a debugger processing the ELF file.

Aspects of the present invention include a method, system, and computer program product for limiting access of sensitive data in a microservice during a debugging process. For example, a computer-implemented method includes: initiating a confidential computing sensitive mode; applying a compilation keyword ccs to tag and protect sensitive data within code; flagging any code elements with the compilation keyword ccs and associating the flagged code elements with a new attribute; generating an enhanced reply packet with a protect flag have a value of true in response to a debugger processing a file containing the new attribute ; and denying access to sensitive data in response to parsing the enhanced reply packet and determining that the protect flag has the value of true.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as preventing information leaking code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

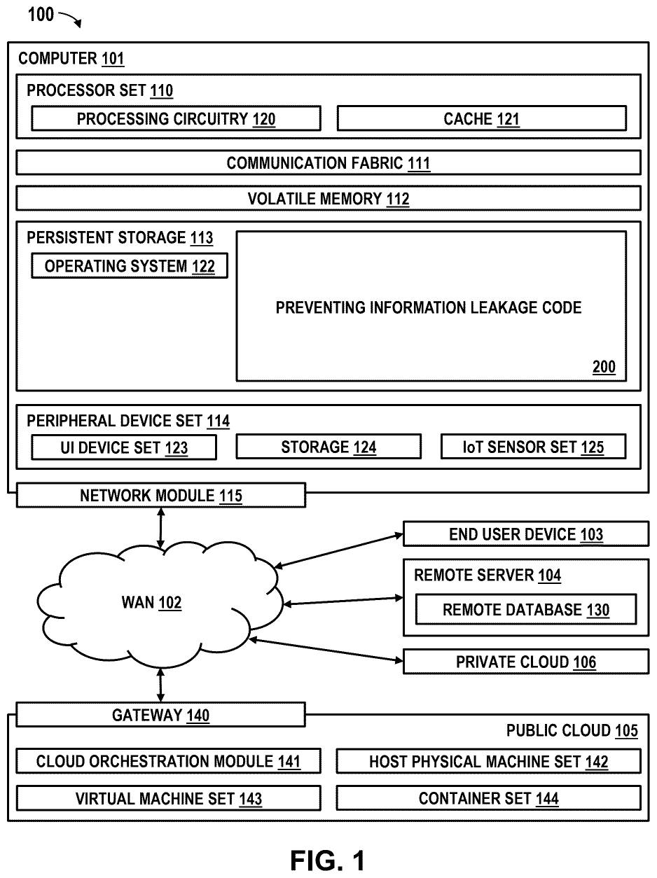

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

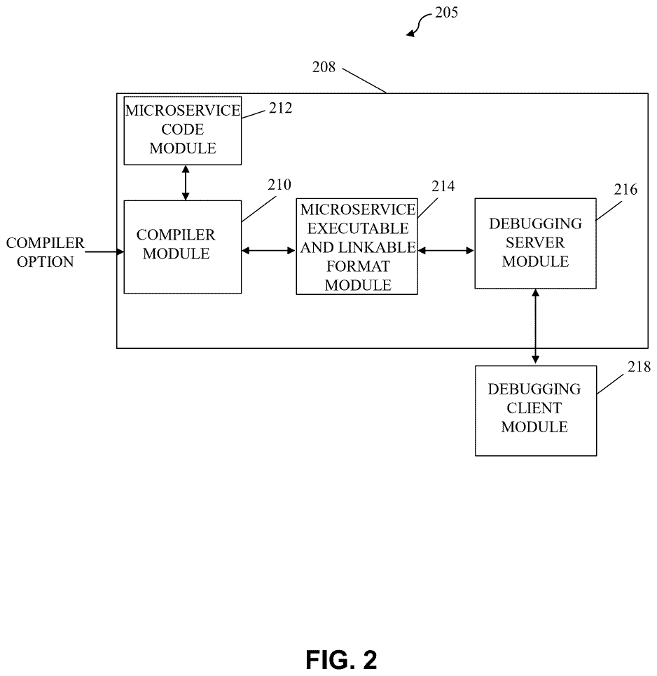

FIG. 2 shows a block diagram of an exemplary environment 205 in accordance with aspects of the present invention. In embodiments, the environment 205 includes a leakage prevention server 208, which may comprise one or more instances of the computer 101 of FIG. 1. In other examples, the leakage prevention server 208 comprises one or more virtual machines or one or more containers running on one or more instances of the computer 101 of FIG. 1.

In embodiments, the leakage prevention server 208 of FIG. 2 comprises a compiler module 210, a microservice code module 212, a microservice executable and linkable format module 214, and a debugging server module 216, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The leakage prevention server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2. For example, a debugging client module 218 may be within the environment 205 and external to the leakage prevention server 208. In embodiments, the debugging client module 218 runs on another computing device that is separate from the leakage prevention server 208.

In aspects of the present invention, the compiler module 210, the microservice code module 212, and the microservice executable and linkable format module 214 of the leakage prevention server 208 are part of a build environment which performs compilation of code. In further embodiments of the present invention, the debugging server module 216 of the leakage prevention server 208 is part of a confidential computing environment which is a runtime environment for executing the code. In further aspects of the present invention, the debugging client module 218 is part of a debugging client tool which either displays variable values of the code or prevents access to the code. In further aspects of the present invention, the variable values of the code comprises a value of the variables “s1” and “s2” in the code.

In accordance with aspects of the present invention, the compiler module 210 receives a compiler option from an external application. In further aspects of the present invention, the external application comprises an application of a computing device which is external to the leakage prevention server 208. In embodiments, the compiler module 210 receives the compiler option to enable a data protection compilation mode from the external application comprising a developer tool application. In further embodiments, the microservice code module 212 automatically adds a compilation keyword ccs before variables of the code that need protection and sends the compilation keyword ccs with the variable of the code to the compiler module 210. In aspects of the present invention, the compilation keyword ccs is a predetermined keyword within a source code which is used as a trigger to denote sensitive and confidential data. In an example, the microservice code module 212 is configured to add the compilation keyword ccs before an integer named “s1” which enables the data protection compilation mode and sends the compilation keyword ccs with the variable of the code to the compiler module 210. In further embodiments, the integer “s1” comprises an integer variable within the microservice code. In other embodiments, the compilation keyword ccs may be manually entered before the variable of the code that enables the data protection compilation mode (i.e., manually enter the compilation keyword ccs in a situation where the compiler option is not received) and sends the compilation keyword ccs with the variable of the code to the compiler module 210.

In embodiments, the compiler module 210 receives the compiler option from the external application and generates a debugging information entry information with the new attribute. In other embodiments, the compiler module 210 receives the compilation keyword ccs with the variable of the code and generates the debug information entry information with the new attribute. The compiler module 210 then packages and sends the debugging information entry information with the new attribute to the microservice executable and linkable format module 214. The microservice executable and linkable format module 214 embeds the debugging information entry information with the new attribute into a debugging with an attributed record format (DWARF) section of an executable and linkable format (ELF) file. In aspects of the present invention, the microservice executable and linkable format module 214 embeds the debugging information entry with the new attribute into the DWARF section of the ELF file by inputting the debugging information entry with the new attribute into the DWARF section of the ELF file during a debugging process. The microservice executable and linkable format module 214 then sends the DWARF section of the ELF file, which contains the debugging information entry information with the new attribute, to the debugging server module 216.

In aspects of the present invention, the debugging server module 216 receives the ELF file which contains the debugging information entry information with the new attribute in the DWARF section and performs debugging of the code. In particular, the debugging server module 216 generates an enhanced debugging reply packet with a protect flag with a value of true in response to processing the ELF file which contains the debugging information entry information with the new attribute in the DWARF section during the debugging. The debugging server module 216 sends the enhanced debugging reply packet to the debugging client module 218.

In embodiments of the present invention, the debugging client module 218 receives the enhanced debugging reply packet from the debugging server module 216. The debugging client module 218 displays access denied through a graphical user interface (GUI) in response to determining that the enhanced debugging reply packet includes the protect flag with the value of true. In other embodiments, the debugging client module 218 displays variable values of the code in response to the enhanced debugging reply packet not including the protect flag or the protect flag having the value of false. In further aspects of the present invention, the variable values of the code comprises a value of variables “s1” and “s2”.

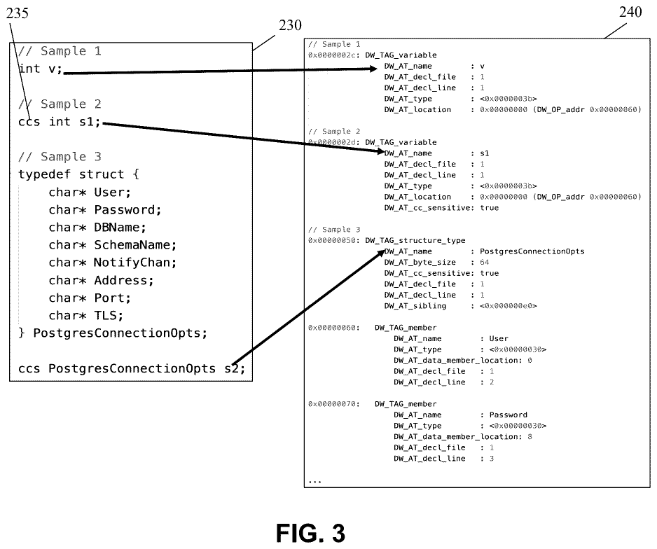

FIG. 3 shows an example of a debugging information file format of the compiler module in accordance with aspects of the present invention. In FIG. 3, the microservice code module 212 automatically adds a compilation keyword ccs 235 before variables “s1” and “s2” of a code 230 that needs protection. In other embodiments, the compilation keyword ccs is manually added (e.g. manually added by a user) before variables “s1” and “s2” of the code 230 that needs protection. In further embodiments of the present invention, the compilation keyword ccs is a predetermined keyword within a source code which is used as a trigger to denote sensitive and confidential data. In further embodiments, the compilation keyword ccs 235 of the code 230 indicates sensitive data. The microservice code module 212 sends the compilation keyword ccs with the variables “s1” and “s2” of the code 230 to the compiler module 210

In further embodiments of FIG. 3, the compiler module 210 parses the code 230, performs semantic analysis, and identifies variables or structures with the compilation keyword ccs of the code 230. The compiler module 210 generates the debugging information entry information with the new attribute DW_at_cc_sensitive 240. In embodiments, the reference numeral 240 represents the debugging information entry with the new attribute named “DW_at_cc_sensitive”. The compiler module 210 then packages and sends the debugging information entry information with the new attribute DW_at_cc_sensitive 240 to the microservice executable and linkable format module 214. The microservice executable and linkable format module 214 embeds the debugging information entry information with the new attribute DW_at_cc_sensitive 240 into debugging with an attributed record format (DWARF) entries of a final executable and linkable format (ELF) binary file. Accordingly, the DWARF entries with the new attribute indicates that these variables “s1” and “s2” or structures are inaccessible to the debugger.

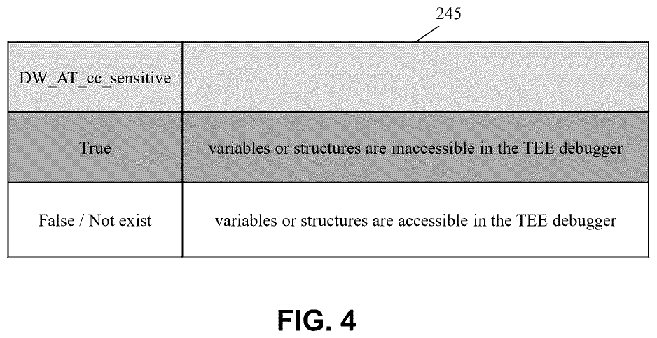

FIG. 4 shows an example of a new attribute of the debugging server module in accordance with aspects of the present invention. In FIG. 4, a table 245 shows that there are two values of the new attribute DW_at_cc_sensitive. In the table 245, the new attribute with a value of true indicates that the variables or structures of the code 230 are inaccessible by the TEE debugger (i.e., protects sensitive data of the variables or structure of the code 230 during a debugging session). Further, in the table 245, the new attribute with a value of false or the new attribute not existing indicates that the variables or structures are accessible by the TEE debugger (i.e., allows access of the variables or structures of the code 230 during the debugging session).

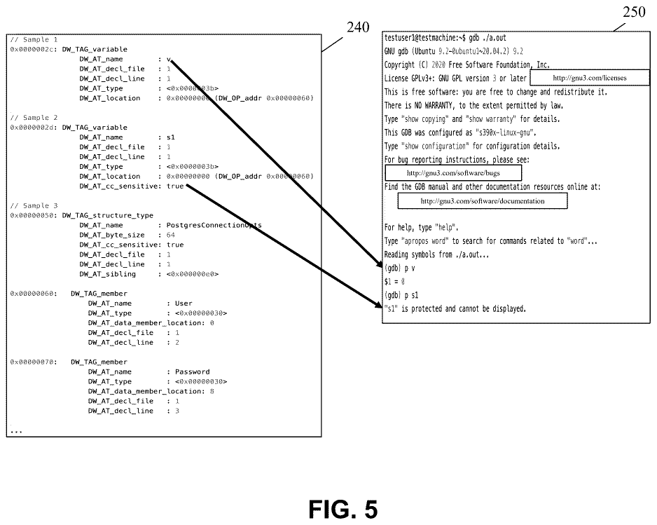

FIG. 5 shows an example of parsing the debugging information filing format of the debugging server module in accordance with aspects of the present invention. In FIG. 5, the debugging server module 216 receives and parses the ELF file which contains the debugging information entry information with the new attribute DW_at_cc_sensitive 240 in the DWARF section and performs debugging of the code 230. In embodiments, the debugging server module 216 parses the ELF file by analyzing and processing the ELF file to extract the debugging entry information with the new attribute DW_att_cc_sensitive 240 to generate an enhanced debugging reply packet. In aspects of the present invention, the reference numeral 240 represents the debugging information entry with the new attribute named “DW_at_cc_sensitive”. The debugging server module 216 generates the enhanced debugging reply packet with a protect flag having a value of true (i.e., 1 or protected) in response to processing the ELF file which contains the debugging information entry information with the new attribute DW_at_cc_sensitive 240 in the DWARF section during the debugging. In this scenario, the debugging server module 216 does not write or allow access to any variable or structure value into the enhanced debugging reply packet. The debugging server module 216 sends the enhanced debugging reply packet to the debugging client module 218. The debugging client module 218 displays access denied through the GUI 250 in response to determining that the enhanced debugging reply packet includes the protect flag with the value of true.

In aspects of the present invention, the debugging server module 216 generates an enhanced debugging reply packet with a protect flag having a value of false (i.e., 0 or not protected) in response to processing the ELF file which contains the debugging information entry information without the new attribute DW_at_cc_sensitive 240 in the DWARF section during the debugging session. In this scenario, the debugging server module 216 writes or enables access to the variable or structure value into the enhanced debugging reply packet. The debugging server module 216 sends the enhanced debugging reply packet to the debugging client module 218. The debugging client module 218 displays the variable or structure value of the code 230 in response to the enhanced debugging reply packet not including the protect flag or the protect flag having the value of false.

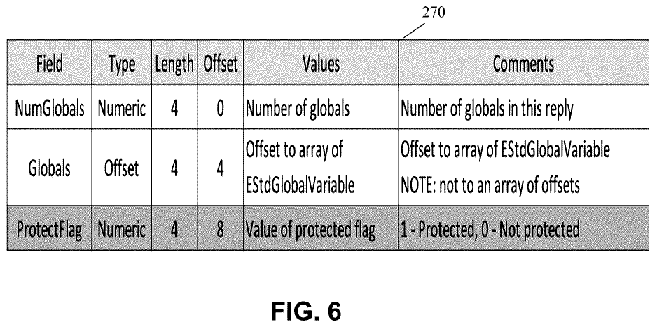

FIG. 6 shows an example of a debugging reply packet of the debugging server module in accordance with aspects of the present invention. In FIG. 6, the debugging reply packet 270 includes the field “protectflag” with a numeric value. In the debugging replay packet 270, the field “protectflag” has a value of true (i.e., 1 or protected) which indicates that the variable or structure value of the code should be prevented from being accessed. Further, in the debugging replay packet 270, the field “protectflag” has a value of false (i.e., 0 or not protected) or not existing, which indicates that the variable or structure of the code are accessible by the debugger client module 218.

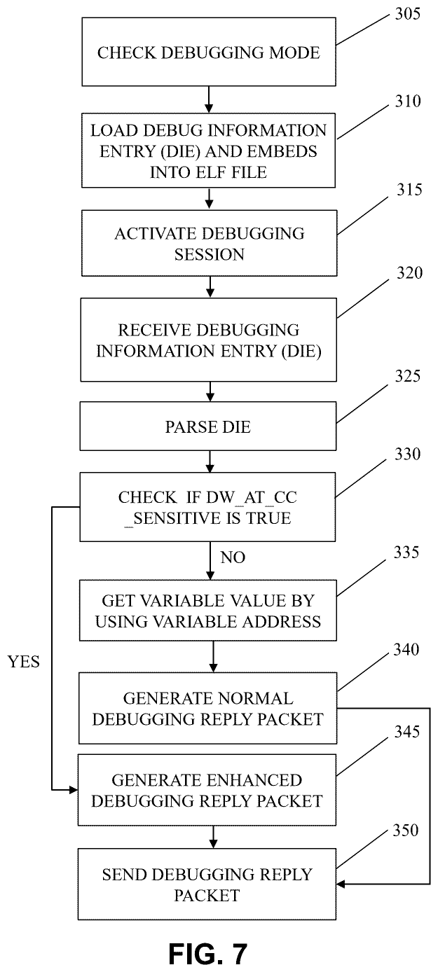

FIG. 7 shows a flowchart of an exemplary method in accordance with aspects of the present invention. Steps of the method may be operations carried out in the environment of FIG. 2 and are described with reference to elements depicted in FIG. 2. In aspects of the present invention, the flowchart of FIG. 7 is directed to a perspective of the leakage prevention server 208.

At step 305, the system checks, at the compiler module 210, a debugging mode. In embodiments and as described with FIG. 2, the compiler module 210 checks a compiler option and whether there is a compilation keyword ccs in order to determine the debugging mode of the code. At step 310, the system loads, at the compiler module 210, the debug information entry with a new attribute named “DW_at_cc_sensitive” and sends the debugging information entry with the new attribute to the microservice executable and linkable format module 214 in response to the debugging mode of the code enabling a data protection compilation. In embodiments and as described with FIG. 2, the microservice executable and linkable format module 214 embeds the debugging information entry with the new attribute DW_at_cc_sensitive into a DWARF section of an ELF file.

At step 315, the system activates, at the debugging server module 216, a debugging session of the code. At step 320, the system receives, at the debugging server module 216, the debugging information entry with new attribute in the DWARF section of the ELF file. At step 325, the system parses, at the debugging server module 216, the debugging information entry with the new attribute in the DWARF section of the ELF file and determines information from the new attribute. In embodiments, the debugging server module 216 parses the ELF file by analyzing and processing the ELF file to extract the debugging entry information with the new attribute DW_att_cc_sensitive 240 to generate an enhanced debugging reply packet.

At step 330, the system checks, at the debugging server module 216, whether the new attribute DW_at_cc_sensitive is true. At step 335, the system gets, at the debugging server module 216, the variable values of the code by using a variable address in response to determining that the new attribute is not true (i.e., NO at step 330). In this situation, the debugging server module 216 gets (i.e., accesses) variable values corresponding to the variable address within the code requested during a debugging process in response to determining that the new attribute is not true. At step 340, the system generates, at the debugging server module 216, a normal debugging reply packet without a protect flag. In this scenario, at step 350, the system sends, at the debugging server module 216, the normal debugging reply packet without the protect flag.

At step 345, the system generates, at the debugging server module 216, an enhanced debugging reply packet with a protect flag with a value of true in response to determining that with the new attribute is true (i.e., YES at step 330). In this scenario, at step 350, the system sends, at the debugging server module 216, the enhanced debugging reply packet with the protect flag with the value of true.

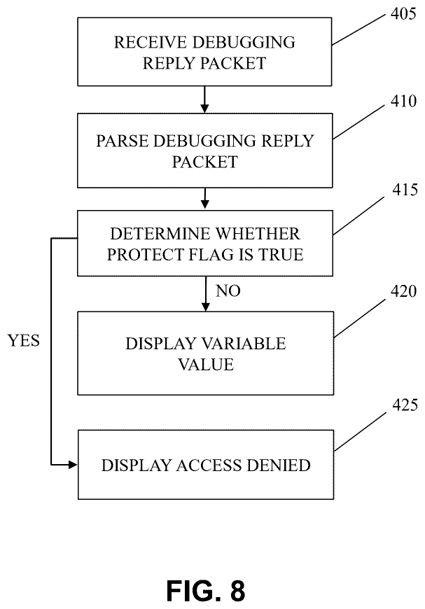

FIG. 8 shows a flowchart of an exemplary method in accordance with aspects of the present invention. Steps of the method may be operations carried out in the environment of FIG. 2 and are described with reference to elements depicted in FIG. 2. In aspects of the present invention, the flowchart of FIG. 8 is directed to a perspective of the debugging client module 218.

At step 405, the system receives, at the debugging client module 218, the debugging reply pocket from the debugging server module 216. At step 410, the system parses, at the debugging client module 218, the debugging reply packet.

At step 415, the system determines, at the debugging client module 218, whether the protect flag is true in the debugging reply packet. At step 420, the system displays, at the debugging client module 218, variable values of the code through a graphical user interface (GUI) in response to determining that the protect flag is not true in the debugging reply packet (i.e., NO at step 415). At step 425, the system displays, at the debugging client module 218, an accessed denied through the GUI in response to determining that the protect flag is true in the debugging reply packet (i.e., YES at step 415). In this scenario, the debugging client module 218 prevents access of the variable values of the code in response to determining that the protect flag is true in the debugging reply packet (i.e., YES at step 415).

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
checking, by a processor set, that a debugging mode of a code enables a data protection compilation;
loading, by the processor set, a debugging information entry with a new attribute having a true value in response to the debugging mode of the code enabling the data protection compilation;
activating, by the processor set, a debugging session of the code;
parsing, by the processor set, the debugging information entry with the new attribute;
determining, by the processor set, that the new attribute has the true value in response to parsing the debugging information entry with the new attribute;
generating, by the processor set, an enhanced debugging reply packet with a protect flag having the true value in response to determining that the new attribute has the true value; and
preventing, by the processor set, access of a variable of the code in response to determining that the new attribute has the true value.

2. The computer-implemented method of claim 1, wherein the checking that the debugging mode of the code enables the data protection compilation comprises receiving a compiler option which enables the data protection compilation.

3. The computer-implemented method of claim 2, wherein the compiler option is received from an external application.

4. The computer-implemented method of claim 3, wherein the external application comprises a developer tool application.

5. The computer-implemented method of claim 1, wherein the checking that the debugging mode of the code enables the data protection compilation comprises receiving a compilation keyword ccs which enables the data protection compilation.

6. The computer-implemented method of claim 5, wherein the compilation keyword ccs is automatically added before the variable of the code.

7. The computer-implemented method of claim 5, further comprising displaying, by the processor set, access denied in response to determining that the new attribute has the true value.

8. The computer-implemented method of claim 1, further comprising outputting, by the processor set, the generated enhanced debugging reply packet with the protect flag having the true value to a debugger client.

9. The computer-implemented method of claim 8, wherein the debugger client displays access denied in response to receiving the generated enhanced debugging reply packet with the protect flag having the true value.

10. The computer-implemented method of claim 1, further comprising embedding, by the processor set, the new attribute into a debugging with an attributed record format (DWARF) section of an executable and linkable (ELF) file.

11. The computer-implemented method of claim 1, wherein the enhanced debugging reply packet with the protect flag having the true value is generated during the debugging session of the code.

12. A computer program product comprising:
one or more computer-readable storage media; and
program instructions stored on the one or more computer-readable storage media to perform operations comprising:
receiving a debugging reply packet which corresponds to a code;
parsing the debugging reply packet;
determining whether a protect flag is true within the debugging reply packet in response to parsing the debugging reply packet;
displaying access denied in response to determining that the protect flag is true within the debugging reply packet; and
displaying a variable of the code in response to determining that the protect flag is not true within the debugging reply packet.

13. The computer program product of claim 12, wherein the operations further comprise accessing the variable of the code in response to determining that the protect flag is true within the debugging reply packet.

14. The computer program product of claim 12, wherein the variable of the code comprises an integer.

15. The computer program product of claim 12, wherein the variable of the code comprises a structure.

16. The computer program product of claim 12, wherein a debugging mode of the code enables a data protection compilation.

17. The computer program product of claim 12, wherein a debugging mode of the code does not enable a data protection compilation.

18. The computer program product of claim 12, whether the operations further comprise requesting the debugging reply packet which corresponds to the code from a debugging server.

19. The computer program product of claim 18, wherein the debugging server is part of a confidential computing environment.

20. A system comprising:
a processor set;
one or more computer-readable storage media; and
program instructions stored on the one or more computer-readable storage media to cause the processor set to perform operations comprising:
checking that a debugging mode of a code enables a data protection compilation;
loading a debugging information entry with a new attribute having a true value in response to the debugging mode of the code enabling the data protection compilation;
activating a debugging session of the code;
parsing the debugging information entry with the new attribute;
determining that the new attribute has the true value in response to parsing the debugging information entry with the new attribute;
generating an enhanced debugging reply packet with a protect flag having the true value in response to determining that the new attribute has the true value;
outputting the generated enhanced debugging reply packet with the protect flag having the true value; and
preventing access of a variable of the code in response to determining that the new attribute has the true value.
